(19) United States
(12) Patent Application Publication
(10) Pub. No.: US 2025/0365245 A1
(43) Pub. Date: Nov. 27, 2025

(54) MEDIA ACCESS CONTROL ADDRESS TABLE UPDATING DEVICE

(71) Applicant: Realtek Semiconductor Corporation, Hsinchu (TW)

(72) Inventors: Che CHEN, Hsinchu (TW); Chun Hsin LIEN, Hsinchu (TW); Chun-Da WU, Hsinchu (TW)

(21) Appl. No.: 19/206,084

(22) Filed: May 13, 2025

(30) Foreign Application Priority Data
May 23, 2024 (TW) 113119152

(51) Int. Cl. H04L 47/30; H04L 47/12; H04L 69/324

(52) U.S. Cl. CPC H04L 47/30; H04L 47/12; H04L 69/324

(57) ABSTRACT

A media access control address table updating device is provided. The device includes a processor, a storage, a learning controller, a packet generator, and a traffic manager. The traffic manager determines whether to generate a first back pressure signal based on a current traffic corresponding to a plurality of queues. In response to determining that the first back-pressure signal is generated, the traffic manager transmits the first back-pressure signal to the packet generator. In response to receiving the first back pressure signal from the traffic manager, the packet generator stops generating a notification packet corresponding to a notification event.

### CROSS-REFERENCE TO RELATED APPLICATION

This application claims priority to Taiwan Application Serial Number 113119152, filed May 23, 2024, which is herein incorporated by reference in its entirety.

### BACKGROUND

### Field of Invention

The present invention relates to a media access control address table updating device. More particularly, the present invention relates to a media access control address table updating device capable of updating a media access control address table.

### Description of Related Art

In the operation of an Ethernet Switch, the Media Access Control (MAC) address table plays an important role in determining the forwarding destination.

Specifically, the media access control address table stored in the switch device maintains mapping relationships between the MAC address and a plurality of switch device ports. When the switch device receives a packet, the switch device checks the MAC address corresponding to the source packet and updates the media access control address table to associate the MAC address with the input port.

Based on the foregoing operation, the switch device can learn the current network topology relationship, and when receiving a packet for a specific MAC address, the switch device can forward it according to the appropriate port. However, during the process of forwarding packets, if the contents of the media access control address table stored by the switch device are incorrect, it will cause table lookup errors on the switch device and lead to unexpected forwarding behavior.

In addition, in some related applications, the software executed on the processor (CPU) will need to know the status of the current media access control address table (for example: L2 table) in real time. Therefore, when there are any changes to the L2 table stored in hardware, an update method must be provided to notify the processor.

Accordingly, there is an urgent need for a media access control address table update technology that can update the media access control address table.

### SUMMARY

An objective of the present disclosure is to provide a media access control address table updating device. The media access control address table updating device comprises a storage, a learning controller, a packet generator, and a traffic manager. The learning controller is electrically connected to the storage and a plurality of network ports. The packet generator is electrically connected to the learning controller. The traffic manager is electrically connected to the packet generator and a processor. The storage is configured to store a media access control address table. The traffic manager is configured to manage a plurality of queues connected to the processor. The traffic manager determines whether to generate a first back pressure signal based on a current traffic corresponding to the plurality of queues. In response to determining that the first back pressure signal is generated, the traffic manager transmits the first back pressure signal to the packet generator. In response to receiving the first back pressure signal from the traffic manager, the packet generator stops generating a notification packet corresponding to a notification event, wherein the notification event is generated by the learning controller based on an update event corresponding to the plurality of network ports, and the notification packet is configured to indicate an update information corresponding to the media access control address table.

Another objective of the present disclosure is to provide a media access control address table updating device. The media access control address table updating device comprises a stacking port, a storage, a learning controller, a packet generator, and a traffic manager. The stacking port is configured to communicatively connect to a first media access control address table updating device. The learning controller is electrically connected to the storage and a plurality of network ports. The packet generator is electrically connected to the learning controller. The traffic manager is electrically connected to the packet generator and a processor. The storage is configured to store a media access control address table. The traffic manager is configured to manage a plurality of queues connected to the processor. The stacking port receives a congestion signal, wherein the congestion signal indicates a queue status corresponding to the first media access control address table updating device. The traffic manager determines whether the queue status of the first media access control address table updating device is a congestion status. In response to the queue state of the first media access control address table updating device being the congestion state, the traffic manager stops transmitting a notification packet corresponding to a notification event to the first media access control address table updating device, wherein the notification event is generated by the learning controller based on an update event corresponding to the plurality of network ports, and the notification packet is configured to indicate an update information corresponding to the media access control address table.

Another objective of the present disclosure is to provide a media access control address table updating device. The media access control address table updating device comprises a storage, a learning controller, a packet generator, and a traffic manager. The learning controller is electrically connected to the storage and a plurality of network ports. The packet generator is electrically connected to the learning controller. The traffic manager is electrically connected to the packet generator and a processor. The storage is configured to store a media access control address table. The traffic manager is configured to manage a plurality of queues connected to the processor. The learning controller receives a plurality of update events. The learning controller removes a duplicate event from the plurality of update events to update the plurality of update events. The learning controller updates the media access control address table based on the plurality of update events, and transmits a plurality of notification events corresponding to the plurality of update events to the packet generator. The packet generator generates a plurality of notification packets corresponding to the plurality of notification events, wherein the notification packet is configured to indicate an update information corresponding to the media access control address table.

According to the above descriptions, the media access control address table updating technology provided by the present disclosure uses a variety of different mechanisms to pre-determine the congestion situation between devices or reduce the burden of transmission traffic, so as to actively stop the operation of the device or temporarily stop updating the media access control address table. Since the media access control address table update technology provided by the present disclosure can dynamically adjust the update operation based on a variety of update mechanisms, it can effectively prevent the media access control address table update failure, improve the operating efficiency of the switch device, and reduce the time cost of transmission and the burden of transmitting data amount.

The detailed technology and preferred embodiments implemented for the subject disclosure are described in the following paragraphs accompanying the appended drawings for people skilled in this field to well appreciate the features of the claimed disclosure.

### BRIEF DESCRIPTION OF THE DRAWINGS

FIG. 1 is a schematic diagram depicting the architecture of a media access control address table updating device of some embodiments;

FIG. 2 is a schematic diagram depicting the architecture of a media access control address table updating device of some embodiments;

FIG. 3 is a schematic diagram depicting the architecture of a media access control address table updating device of some embodiments; and

FIG. 4 is a schematic diagram depicting the congestion signal format of some embodiments.

### DETAILED DESCRIPTION

In the following description, a media access control address table updating device according to the present disclosure will be explained with reference to embodiments thereof. However, these embodiments are not intended to limit the present disclosure to any environment, applications, or implementations described in these embodiments. Therefore, the description of these embodiments is only for purpose of illustration rather than to limit the present disclosure. It shall be appreciated that, in the following embodiments and the attached drawings, elements unrelated to the present disclosure are omitted from depiction. In addition, dimensions of individual elements and dimensional relationships among individual elements in the attached drawings are provided only for illustration but not to limit the scope of the present disclosure.

First, the application environment of the present disclosure is explained. In the present disclosure, in order to allow multiple switch devices (for example, stacked topology environment) or processors to obtain the correct contents of the media access control address table in real time, when the status of a network port changes, the switch device needs to actively notify the local processor or remote switch device to update (for example: the processor of the local switch device or the processor of the remote switch device) by packaging the update event (for example: L2 notification) into a packet, so as to synchronize the information about the media access control address table in multiple switch devices.

The problem to be solved by the present disclosure is that during the execution of the aforementioned operation, there may be multiple reasons (for example: a large number of port move events occurring in a short period of time, traffic restrictions, packet congestion, etc.), causing subsequent incoming update events cannot be processed in a timely manner, causing the update event to be lost or the packet to be discarded, and causing the problem that the media access control address table of the local switch device fails to update and the media access control address table of each switch device cannot be synchronized. The present disclosure can solve the aforementioned problems through a variety of mechanisms. The following paragraphs will detail the implementation methods of the present disclosure to solve the aforementioned problems.

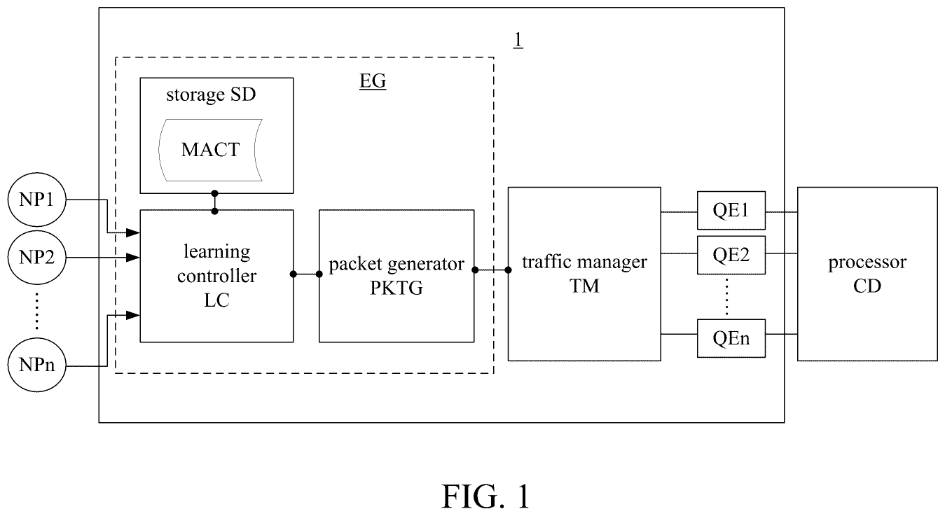

The first embodiment of the present disclosure is a media access control address table updating device 1, and its schematic diagram is depicted in FIG. 1. The media access control address table updating device 1 comprises a storage SD, a learning controller LC, a packet generator PKTG, and a traffic manager TM.

In the present embodiment, the learning controller LC is electrically connected to the storage SD and a plurality of network ports NP1, NP2, . . . , NPn. The learning controller LC is configured to identify update events of the plurality of network ports NP1, NP2, . . . , NPn. The packet generator PKTG is electrically connected to the learning controller LC, and the packet generator PKTG is configured to generate notification packets. The traffic manager TM is electrically connected to the packet generator PKTG and a processor CD, and the traffic manager TM is configured to manage a plurality of queues QE1, QE2, . . . , QEn (for example: which queue to transmit notification packets).

It shall be appreciated that the electrical connection referred to in the present disclosure may comprise a direct connection relationship (i.e., directly connected) or an indirect connection relationship (i.e., reaching through other components or paths). For example, the packet generator PKTG can transmit signals/data to the traffic manager TM through other components (e.g., registers). For another example, the traffic manager TM can transmit signals/data to the processor CD through other components (e.g., registers).

In some embodiments, as shown in FIG. 1, the storage SD, the learning controller LC, and the packet generator PKTG can be integrated into an event generator EG.

It shall be appreciated that in the present disclosure, the learning controller LC, the packet generator PKTG, and the traffic manager TM can implement their functions through corresponding hardware (for example: integrated circuits), and can be integrated and installed on the same electronic chip.

In some embodiments, the media access control address table updating device 1 can be integrated in the switch device or the corresponding functions can be performed by components of the switch device. Those with ordinary knowledge in the art should be able to understand the implementation of the learning controller LC, the packet generator PKTG, and the traffic manager TM based on the contents disclosed in the present disclosure, so no further details are given.

In the present embodiment, the storage SD is configured to store a media access control address table MACT (for example: L2 table). The media access control address table MACT stores the mapping relationship between the MAC address and a plurality of switch device ports.

It shall be appreciated that the storage SD may be a Universal Serial Bus (USB) disk, a hard disk, a Compact Disk (CD), a mobile disk, or any other storage medium or circuit known to those of ordinary skill in the art and having the same functionality. The processor CD may be any of various processors, Central Processing Units (CPUs), microprocessors, digital signal processors or other computing apparatuses known to those of ordinary skill in the art.

In order to facilitate understanding of the content of the present disclosure, the basic operation of the present disclosure regarding update of update events is briefly explained. First, the plurality of network ports NP1, NP2, . . . , NPn input update events to the learning controller LC (for example: traffic injection/aging information). Then, the learning controller LC determines whether to write the update event into the media access control address table MACT, and generates a corresponding notification event to the packet generator PKTG. Then, the packet generator PKTG generates a notification packet based on the notification event, and transmits the notification packet to the traffic manager TM. Finally, the traffic manager TM transmits a notification packet to notify the local processor CD or the processor of the remote device to update the update event, and the notification packet is configured to indicate the updated information corresponding to the media access control address table MACT.

It shall be appreciated that the plurality of notification events can be actively generated by the learning controller LC or generated based on the update events of the plurality of network ports NP1, NP2, . . . , NPn.

In some embodiments, the plurality of update events may comprise an aging-out event, a link-down flush event, a new learn event, and a port move event.

For example, when there is no packet update for a period of time, the learning controller LC will generate a notification event about the aging event to delete the information corresponding to the aging event from the media access control address table MACT (e.g., the mapping relationship has not been updated for more than a preset period of time). In addition, when the link is not running, the learning controller LC will generate a notification event about the link shutdown refresh event to delete the information from the media access control address table MACT.

For another example, when a new source MAC enters the media access control address table updating device 1, the learning controller LC will generate a notification event about the new learning event to add the information from the media access control address table MACT (e.g., corresponding to the mapping relationship between the new source MAC and the switch device port). In addition, when the existing source MAC changes the network port, the learning controller LC will generate a notification event about the port move event to update the information from the media access control address table MACT.

In the present disclosure, at least five mechanisms are provided to solve the problem of missing update events or packet discarding. Specifically, the aforementioned five mechanisms comprise a self-defined packet control mechanism, an event suppression mechanism, a back pressure mechanism, a bypass CPU egress port rate per queue mechanism, and an end-to-end congestion control mechanism.

It shall be appreciated that the media access control address table updating device 1 can be implemented based on one of the aforementioned five mechanisms or a combination of multiple mechanisms (e.g., using both the self-defined packet control mechanism and the back pressure mechanism), the specific implementation details of each mechanism will be described in detail below.

First, the operation method of the self-defined packet control mechanism of the present disclosure will be explained below. In some embodiments, in order to solve the problem of lost packets caused by too many packets, the media access control address table updating device 1 can define packet generation conditions (for example, defined by software) through a self-defined packet control mechanism, so as to control the number of notification packets generated.

For example, the media access control address table updating device 1 can control the number of notification packets generated based on event-based condition, time-based condition, or both based on the event-based condition and the time-based condition.

Specifically, based on event-based conditions, the media access control address table updating device 1 can accumulate a defined number of notification events (for example: every 10 notification events) before merging them into notification packets and sending them out, so as to reduce bandwidth usage and reduce packet processing load.

For example, the media access control address table updating device 1 can control the number of notification events input to the packet generator PKTG by the learning controller LC, or can control the generation of notification packets based on the defined number of notification events by the packet generator PKTG.

For another example, in the embodiment of the time-based condition, the media access control address table updating device 1 can collect notification events within a defined period of time (for example: every 100 ms) before merging them into notification packets and sending them out.

In some embodiments, the MAC address table updating device 1 further performs the following operations. The packet generator PKTG generates the notification packet based on at least one packet generation condition, wherein the at least one packet generation condition comprises at least one of an event quantity condition and a time condition or a combination thereof.

Next, the operation method of the event suppression mechanism of the present disclosure will be described below. In some cases (for example, frequent port move events in switch device loops, or the time lag before new learning events are actually updated to the media access control address table MACT), the switch device may generate the same type of update events in a short period of time.

In order to solve the aforementioned problems, in some embodiments, the media access control address table updating device 1 can set a time controller through an event suppression mechanism to record a plurality of update events within a time interval, and the media access control address table updating device 1 removes the update events with the same content within the time interval (for example, duplicate port movement events generated by switch device loops).

It shall be appreciated that in the present disclosure, all types of update events may use the same time controller setting or different types of update events may use separate time controller settings.

Specifically, the learning controller LC receives a plurality of update events from the plurality of network ports NP1, NP2, . . . , NPn. Then, the learning controller LC removes a duplicate event from the plurality of update events to update the plurality of update events. Then, the learning controller LC updates the media access control address table MACT based on the plurality of update events, and transmits a plurality of notification events corresponding to the plurality of update events to the packet generator PKTG. Finally, the packet generator PKTG generates a plurality of notification packets corresponding to the plurality of notification events, wherein the notification packet is configured to indicate an update information corresponding to the media access control address table MACT.

In some embodiments, the operation of removing the duplicate event from the plurality of update events comprises the following operations. First, the learning controller LC records a type event and a time interval corresponding to each of the plurality of update events. Then, for each of the plurality of types of events, the learning controller LC removes the duplicate event corresponding to the time interval from the plurality of update events to update the plurality of update events.

In some embodiments, a register (not shown) may be set between the learning controller LC and the packet generator PKTG. The register is electrically connected to the learning controller LC and the packet generator PKTG, and the register is configured to store the notification event generated by the learning controller LC. Specifically, the register is configured to temporarily store the notification event and provide the notification event to the packet generator PKTG according to the corresponding output rule (for example: First In First Out (FIFO) algorithm).

In some embodiments, a register can be set between the packet generator PKTG and the traffic manager TM. The register is configured to temporarily store the notification packet and provide the notification packet to the traffic manager TM according to the corresponding output rule (for example: FIFO algorithm).

In some embodiments, the MAC address table updating device 1 further executes the following operations. The packet generator PKTG generates the notification packet based on at least one packet generation condition, wherein the at least one packet generation condition comprises at least one of an event quantity condition and a time condition or a combination thereof.

Next, the operation method of the back pressure mechanism of the present disclosure will be explained below. In some cases, the media access control address table updating device 1 may suffer from the problem of loss of subsequent transmission data due to too much data waiting to be processed in each component. In order to solve the aforementioned problem, in some embodiments, the media access control address table updating device 1 can use a back pressure mechanism to determine in advance whether the current traffic of the register is higher than the threshold, so as to notify other components to suspend execution operations and stop updating the media access control address table MACT.

Specifically, the traffic manager TM determines whether to generate a first back pressure signal based on a current traffic corresponding to the plurality of queues QE1, QE2, . . . , QEn. Then, in response to determining that the first back-pressure signal is generated, the traffic manager TM transmits the first back-pressure signal to the packet generator PKTG. Then, in response to receiving the first back pressure signal from the traffic manager TM, the packet generator PKTG stops generating a notification packet corresponding to a notification event, wherein the notification event is generated by the learning controller LC based on an update event corresponding to the plurality of network ports, and the notification packet is configured to indicate an update information corresponding to the media access control address table MACT.

In some embodiments, the operation of determining whether to generate a first back pressure signal comprises the following operations. First, the traffic manager TM determines whether the current traffic corresponding to the plurality of queues QE1, QE2, . . . , QEn is higher than a traffic threshold (for example: 95% of the maximum traffic). Then, in response to the current traffic corresponding to the plurality of queues QE1, QE2, . . . , QEn being higher than the traffic threshold, the traffic manager TM generates the first back pressure signal.

It shall be appreciated that the traffic manager TM can set corresponding traffic thresholds for each of the plurality of queues QE1, QE2, . . . , QEn, or sum up the overall traffic amount of all queues to make a judgment.

In some embodiments, the packet generator PKTG may further notify the learning controller LC to stop updating the media access control address table MACT after determining its congestion status.

Specifically, in response to receiving the first back pressure signal from the traffic manager TM, the packet generator PKTG further performs the following operations. First, the packet generator PKTG determines whether a current temporary storage space for storing the notification event is higher than a temporary storage space threshold (for example: 95% of the maximum storage capacity). Then, in response to the current temporary storage space being higher than the temporary storage space threshold, the packet generator PKTG generates a second back pressure signal. Finally, the packet generator PKTG transmits the second back pressure signal to the learning controller LC, wherein the second back pressure signal is configured to instruct the learning controller LC to stop updating the media access control address table MACT.

In some embodiments, the operation of generating the second back pressure signal further comprises the following operations. First, the packet generator PKTG determines whether the current temporary storage space of the register storing the notification event is higher than the temporary storage space threshold. Then, in response to the current temporary storage space being higher than the temporary storage space threshold, the packet generator PKTG generates the second back pressure signal.

In some embodiments, before the learning controller LC performs the operation of the media access control address table MACT, the learning controller LC will first check whether there is a back pressure signal, and then decide whether to perform the update/write operation.

Specifically, the learning controller LC receives at least one new update event from the plurality of network ports NP1, NP2, . . . , NPn. Then, the learning controller LC determines whether the second back pressure signal exists. Next, in response to that the second back pressure signal does not exist, the learning controller LC updates the media access control address table MACT based on the at least one new update event, and transmits the notification event corresponding to the at least one new update event to the packet generator PKTG.

In addition, in response to that the second back pressure signal exists, the learning controller LC stops updating the media access control address table MACT, and stops transmitting the notification event corresponding to the at least one new update event to the packet generator PKTG.

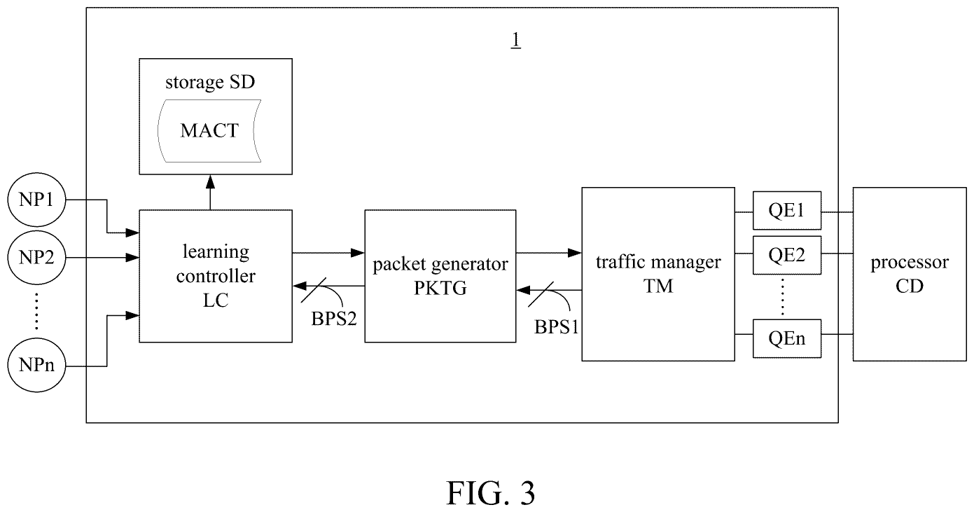

For ease of understanding, please refer to FIG. 3. In the present example, since the traffic manager TM determines that the current traffic of queues QE1, QE2, . . . , QEn is higher than the traffic threshold, the traffic manager TM generates the first back pressure signal BPS1 and transmits the first back pressure signal BPS1 to the packet generation PKTG. Next, in response to receiving the first back pressure signal BPS1 from the traffic manager TM, the packet generator PKTG stops generating a notification packet corresponding to a notification event.

In addition, in the present example, since the packet generator PKTG determines that the current temporary storage space for storing the notification event is higher than the temporary storage space threshold, the packet generator PKTG generates the second back pressure signal BPS2 and transmits the second back pressure signal BPS2 to the learning controller LC.

In the present example, when the learning controller LC receives new update events from the plurality of network ports NP1, NP2, . . . , NPn, the learning controller LC will first determine whether the second back pressure signal BPS2 exists. When the second back pressure signal BPS2 does not exist, the learning controller LC will perform the subsequent operation of writing/updating the media access control address table MACT.

On the contrary, when the second back pressure signal BPS2 exists, the learning controller LC will stop the operation of writing/updating the media access control address table MACT, and stop transmitting the notification event corresponding to the new update event to the packet generator PKTG.

Next, the following will explain the operation method of the present disclosure regarding the Bypass CPU egress port rate per queue mechanism. In some cases, traffic control can be performed on the queue to prevent too many packets from being transmitted to the processor in a short period of time and unable to be processed. However, in this situation, the notification packet will also be affected by this flow control and cannot be updated immediately.

In order to solve the aforementioned problem, in some embodiments, the media access control address table updating device 1 can use the traffic manager TM to set one of several queues QE1, QE2, . . . , QEn as an unlimited queue through the Bypass CPU egress port rate per queue mechanism, so that notification packets transmitted from the unlimited queue can be sent directly to the processor CD by using the additional bandwidth in the queue.

It shall be appreciated that the media access control address table updating device 1 can also be equipped with a suitable scheduling algorithm (for example: Strict Priority algorithm) to ensure that queued notification packets can be transmitted with priority.

For example, the speed limit bandwidth of the plurality of queues QE1, QE2, . . . , QEn is 9G, and each of the plurality of queues QE1, QE2, . . . , QEn is set to use a maximum bandwidth of 5G. However, in fact, these queues still need to share 9G of bandwidth. Therefore, “5*n−9” G packets may be lost (n>1). In the present example, the media access control address table updating device 1 can set the queue QE1 as an unlimited queue and use it to transmit notification packets. Since the queue QE1 is set to have a dedicated bandwidth, it does not need to be limited to the 9G bandwidth.

Next, the operation method of the end-to-end congestion control mechanism of the present disclosure will be described below. In a stacked environment, it may happen that notification packets sent by the local device are discarded due to congestion on the remote device (i.e., the switch device).

In order to solve the aforementioned problems, in some embodiments, the media access control address table updating device 1 can exchange the current queue status of the devices in each stack environment through the end-to-end congestion control mechanism, and maintain the current congestion status of all devices individually. Therefore, as long as the media access control address table updating device 1 finds that the remote queue is already congested, it will stop generating notification packets and make the learning controller LC stop updating the media access control address table MACT.

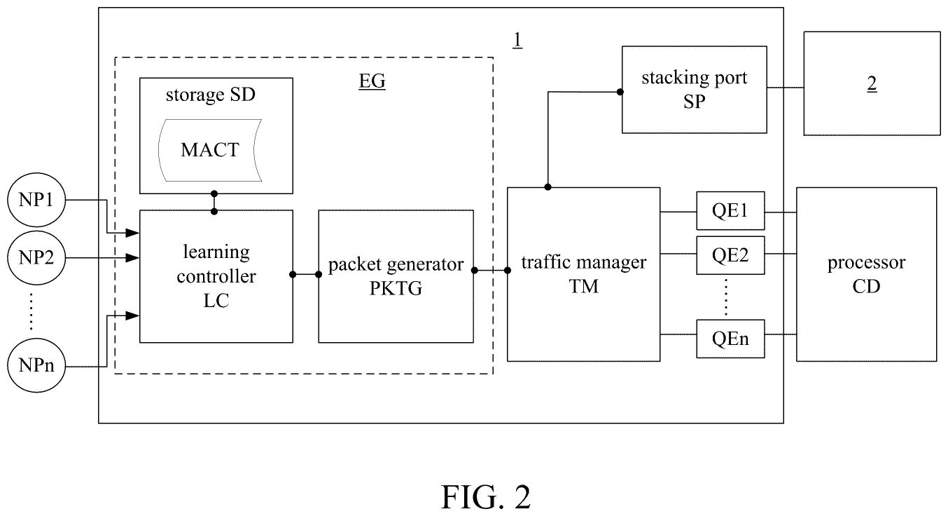

For ease of understanding, please refer to FIG. 2. In the present example, the MAC address table updating device 1 further comprises a stacking port SP. The stacking port SP is configured to communicatively connect to the media access control address table updating device 2.

In the present example, the stacking port SP receives a congestion signal, wherein the congestion signal indicates a queue status of the corresponding media access control address table updating device 2. Then, the traffic manager TM determines whether the queue state of the media access control address table updating device 2 is a congestion state. Finally, in response to the queue state of the media access control address table updating device 2 being the congestion state, the traffic manager TM stops transmitting a notification packet corresponding to a notification event to the first media access control address table updating device.

It shall be appreciated that the notification event is generated by the learning controller LC based on an update event corresponding to the plurality of network ports NP1, NP2, . . . , NPn, and the notification packet is configured to indicate an update information corresponding to the media access control address table MACT.

In the present example, the learning controller LC receives at least one new update event from the plurality of network ports NP1, NP2, . . . , NPn. Then, in response to the traffic manager TM stopping transmitting the notification packet corresponding to the notification event to the media access control address table updating device 2, the learning controller LC stops updating the media access control address table MACT and stops transmitting the notification packet corresponding to the at least one new update event to the packet generator PKTG.

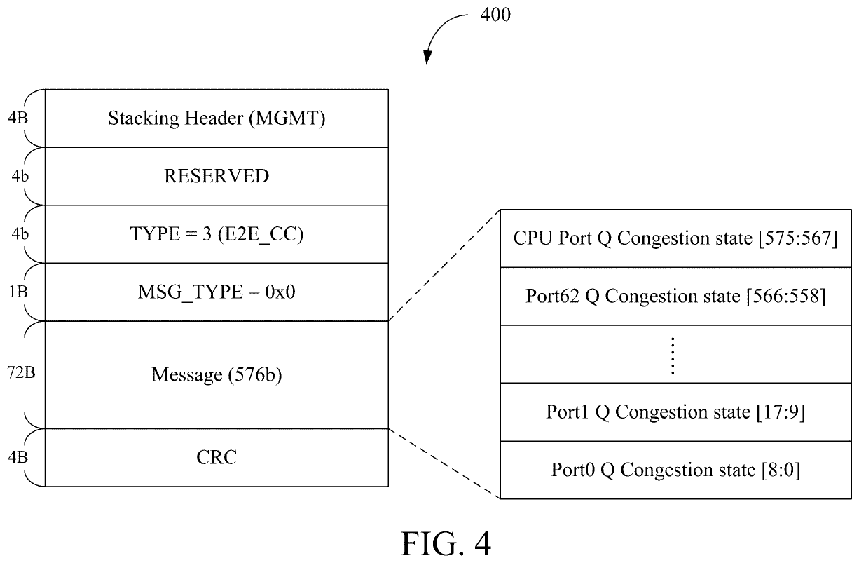

For ease of understanding, please refer to a congestion signal format schematic diagram 400 illustrated in FIG. 4. As shown in FIG. 4, the congestion signal can record the congestion status of the plurality of network ports NP1, NP2, . . . , NPn and the plurality of queues QE1, QE2, . . . , QEn corresponding to different remote devices through the Message field (for example: recording whether it is congestion through 1 bit).

It shall be appreciated that FIG. 2 is only for illustration. The present disclosure does not limit the number of other devices that the stacking port SP is connected to, and the stacking port SP should be connectable to all devices in the stacking environment.

In some embodiments, the MAC address table updating device 1 further performs the following operations. The packet generator PKTG generates the notification packet based on at least one packet generation condition, wherein the at least one packet generation condition comprises at least one of an event quantity condition and a time condition or a combination thereof.

In addition to the aforementioned five individual mechanisms, the media access control address table updating device 1 can be implemented based on a combination of multiple mechanisms. How the embodiment executes these multiple mechanisms to execute these operations and steps, has the same functions, and delivers the same technical effects will be readily appreciated by those of ordinary skill in the art based on the explanation of the present disclosure. Therefore, the details will not be repeated herein.

It shall be appreciated that in the specification and the claims of the present disclosure, some words (e.g., the back pressure signal) are preceded by terms such as “first” or “second”, and these terms of “first” or “second” are only used to distinguish these different words. For example, the “first” and “second” back pressure signals are only used to indicate the back pressure signals used in different operations.

According to the above descriptions, the media access control address table updating technology provided by the present disclosure uses a variety of different mechanisms to pre-determine the congestion situation between devices or reduce the burden of transmission traffic, so as to actively stop the operation of the device or temporarily stop updating the media access control address table. Since the media access control address table update technology provided by the present disclosure can dynamically adjust the update operation based on a variety of update mechanisms, it can effectively prevent the media access control address table update failure, improve the operating efficiency of the switch device, and reduce the time cost of transmission and the burden of transmitting data amount.

The above disclosure is related to the detailed technical contents and inventive features thereof. People skilled in this field may proceed with a variety of modifications and replacements based on the disclosures and suggestions of the disclosure as described without departing from the characteristics thereof. Nevertheless, although such modifications and replacements are not fully disclosed in the above descriptions, they have substantially been covered in the following claims as appended.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A media access control address table updating device, comprising:
a storage, being configured to store a media access control address table;
a learning controller, being electrically connected to the storage and a plurality of network ports;
a packet generator, being electrically connected to the learning controller; and
a traffic manager, being electrically connected to the packet generator and a processor, wherein the traffic manager manages a plurality of queues connected to the processor;
wherein the media access control address table updating device performs the following operations:
determining, by the traffic manager, whether to generate a first back pressure signal based on a current traffic corresponding to the plurality of queues;
in response to determining that the first back pressure signal is generated, transmitting, by the traffic manager, the first back pressure signal to the packet generator; and
in response to receiving the first back pressure signal from the traffic manager, stopping, by the packet generator, generating a notification packet corresponding to a notification event, wherein the notification event is generated by the learning controller based on an update event corresponding to the plurality of network ports, and the notification packet is configured to indicate an update information corresponding to the media access control address table.

2. The media access control address table updating device of claim 1, wherein the operation of determining whether to generate the first back pressure signal comprises the following operations:
determining, by the traffic manager, whether the current traffic corresponding to the plurality of queues is higher than a traffic threshold; and
in response to the current traffic corresponding to the plurality of queues being higher than the traffic threshold, generating, by the traffic manager, the first back pressure signal.

3. The media access control address table updating device of claim 1, wherein the media access control address table updating device further executes the following operations:
in response to receiving the first back pressure signal from the traffic manager, the packet generator further performs the following operations:
determining whether a current temporary storage space for storing the notification event is higher than a temporary storage space threshold;
in response to the current temporary storage space being higher than the temporary storage space threshold, generating, by the packet generator, a second back pressure signal; and
transmitting the second back pressure signal to the learning controller, wherein the second back pressure signal is configured to instruct the learning controller to stop updating the media access control address table.

4. The media access control address table updating device of claim 3, the following operations:
receiving, by the learning controller, at least one new update event from the plurality of network ports;
determining, by the learning controller, whether the second back pressure signal exists;
in response to that the second back pressure signal does not exist, updating, by the learning controller, the media access control address table based on the at least one new update event, and transmitting the notification event corresponding to the at least one new update event to the packet generator; and
in response to that the second back pressure signal exists, stopping, by the learning controller, updating the media access control address table, and stopping transmitting the notification event corresponding to the at least one new update event to the packet generator.

5. The media access control address table updating device of claim 4, wherein the media access control address table updating device further executes the following operations:
generating, by the packet generator, the notification packet based on at least one packet generation condition, wherein the at least one packet generation condition comprises at least one of an event quantity condition and a time condition or a combination thereof.

6. The media access control address table updating device of claim 1, the following operations:
setting, by the traffic manager, one of the plurality of queues to be an unlimited queue; and
transmitting, by the traffic manager, the notification packet to the processor through the unlimited queue.

7. The media access control address table updating device of claim 1, wherein the media access control address table updating device further executes the following operations:
receiving, by the learning controller, at least one new update event;
removing, by the learning controller, a duplicate event from the at least one new update event to update the at least one new update event; and
updating, by the learning controller, the media access control address table based on the at least one new update event, and transmitting a plurality of new notification events corresponding to the at least one new update event to the packet generator.

8. The media access control address table updating device of claim 7, wherein the operation of removing the duplicate event from the at least one new update event comprises the following operations:
recording, by the learning controller, a type event and a time interval corresponding to each of the at least one new update event; and
for each of the plurality of type events, removing, by the learning controller, the duplicate event corresponding to the time interval in the at least one new update event to update the at least one new update event.

9. The media access control address table updating device of claim 3, wherein the media access control address table updating device further comprises:
a register, being electrically connected to the learning controller and the packet generator, and being configured to store the notification event generated by the learning controller.

10. The media access control address table updating device of claim 9, wherein the operation of generating the second back pressure signal further comprises the following operations:
determining, by the packet generator, whether the current temporary storage space of the register storing the notification event is higher than the temporary storage space threshold; and
generating, by the packet generator, the second back pressure signal in response to the current temporary storage space being higher than the temporary storage space threshold.

11. A media access control address table updating device, comprising:
a stacking port, being configured to communicatively connect to a first media access control address table updating device;
a storage, being configured to store a media access control address table;
a learning controller, being electrically connected to the storage and a plurality of network ports;
a packet generator, being electrically connected to the learning controller; and
a traffic manager, being electrically connected to the packet generator and a processor, wherein the traffic manager manages a plurality of queues connected to the processor;
wherein the media access control address table updating device performs the following operations:
receiving, by the stacking port, a congestion signal, wherein the congestion signal indicates a queue status corresponding to the first media access control address table updating device;
determining, by the traffic manager, whether the queue status of the first media access control address table updating device is a congestion status; and
in response to the queue state of the first media access control address table updating device being the congestion state, stopping, by the traffic manager, transmitting a notification packet corresponding to a notification event to the first media access control address table updating device, wherein the notification event is generated by the learning controller based on an update event corresponding to the plurality of network ports, and the notification packet is configured to indicate an update information corresponding to the media access control address table.

12. The media access control address table updating device of claim 11, the following operations:
receiving, by the learning controller, at least one new update event from the plurality of network ports; and
in response to the traffic manager stopping transmitting the notification packet corresponding to the notification event to the first media access control address table updating device, stopping, by the learning controller, updating the media access control address table, and stopping transmitting the notification event corresponding to the at least one new update event to the packet generator.

13. The media access control address table updating device of claim 11, wherein the media access control address table updating device further performs the following operations:
generating, by the packet generator, a plurality of notification packets based on at least one packet generation condition, wherein the at least one packet generation condition comprises at least one of an event quantity condition and a time condition or a combination thereof.

14. The media access control address table updating device of claim 11, wherein the media access control address table updating device further performs the following operations:
setting, by the traffic manager, one of the plurality of queues to be an unlimited queue; and
transmitting, by the traffic manager, the notification packet to the processor through the unlimited queue.

15. The media access control address table updating device of claim 11, wherein the media access control address table updating device further performs the following operations:
receiving, by the learning controller, at least one new update event;
removing, by the learning controller, a duplicate event from the at least one new update event to update the at least one new update event; and
updating, by the learning controller, the media access control address table based on the at least one new update event, and transmitting a plurality of new notification events corresponding to the at least one new update event to the packet generator.

16. The media access control address table updating device of claim 15, wherein the operation of removing the duplicate event from the at least one new update event comprises the following operations:
recording, by the learning controller, a type event and a time interval corresponding to each of the at least one new update event; and
for each of the plurality of type events, removing, by the learning controller, the duplicate event corresponding to the time interval in the at least one new update event to update the at least one new update event.

17. A media access control address table updating device, comprising:
a storage, being configured to store a media access control address table;
a learning controller, being electrically connected to the storage and a plurality of network ports;
a packet generator, being electrically connected to the learning controller; and
a traffic manager, being electrically connected to the packet generator and a processor, wherein the traffic manager manages a plurality of queues connected to the processor;
wherein the media access control address table updating device performs the following operations:
receiving, by the learning controller, a plurality of update events;
removing, by the learning controller, a duplicate event from the plurality of update events to update the plurality of update events;
updating, by the learning controller, the media access control address table based on the plurality of update events, and transmitting a plurality of notification events corresponding to the plurality of update events to the packet generator; and
generating, by the packet generator, a plurality of notification packets corresponding to the plurality of notification events, wherein the notification packet is configured to indicate an update information corresponding to the media access control address table.

18. The media access control address table updating device of claim 17, wherein the operation of removing the duplicate event from the plurality of update events comprises the following operations:
recording, by the learning controller, a type event and a time interval corresponding to each of the plurality of update events; and
for each of the plurality of type events, removing, by the learning controller, the duplicate event corresponding to the time interval from the plurality of update events to update the plurality of update events.

19. The media access control address table updating device of claim 17, wherein the media access control address table updating device further performs the following operations:
generating, by the packet generator, a plurality of notification packets based on at least one packet generation condition, wherein the at least one packet generation condition comprises at least one of an event quantity condition and a time condition or a combination thereof.

20. The media access control address table updating device of claim 17, wherein the media access control address table updating device further performs the following operations:
setting, by the traffic manager, one of the plurality of queues to be an unlimited queue; and
transmitting, by the traffic manager, the notification packet to the processor through the unlimited queue.
